(19) United States
(12) Patent Application Publication
(10) Pub. No.: US 2009/0259395 A1
(43) Pub. Date: Oct. 15, 2009

(54) Speed limit guiding device

(75) Inventor: Eiji Sobue, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/385,376

(22) Filed: Apr. 7, 2009

(30) Foreign Application Priority Data
Apr. 9, 2008 (JP) 2008-101675

(51) Int. Cl. G01C 21/26

(52) U.S. Cl. 701/208

(57) ABSTRACT

A speed limit guiding device includes: a position detector; a information acquisition device for obtaining map information having road information and speed limit information; a determination device for determining whether it is daytime or nighttime; a specifying device for specifying the road, on which the vehicle is disposed; and a guiding device for informing the speed limit information. The guiding device informs a daytime speed limit corresponding to the road, on which the vehicle is disposed, when the determination device determines that it is daytime, and the guiding device informs a nighttime speed limit corresponding to the road, on which the vehicle is disposed, when the determination device determines that it is nighttime.

### CROSS REFERENCE TO RELATED APPLICATION

This application is based on Japanese Patent Application No. 2008-101675 filed on Apr. 9, 2008, the disclosure of which is incorporated herein by reference.

### FIELD OF THE INVENTION

The present invention relates to a speed limit guiding device.

### BACKGROUND OF THE INVENTION

A technique for guiding speed limit information to a user is well known. For example, JP-A-H05-67294 teaches this technique. The speed limit information relates to a road, on which a vehicle runs at this moment. The information is informed to the user based on a current position of the vehicle and the speed limit information stored in a map data.

Further, a technique for informing a warning to the user when a current speed of the vehicle is higher than a previous speed is well known in, for example, JP-A-2003-207348. The previous speed is defined at a time when the vehicle previously ran the same road.

If the speed limit at night is different from the speed limit at daytime, it is not clear which speed limit is applied. Thus, it is required for a guiding device to clarify which speed limit is applied at this moment.

### SUMMARY OF THE INVENTION

In view of the above-described problem, it is an object of the present disclosure to provide a speed limit guiding device.

According to an aspect of the present disclosure, a speed limit guiding device for a vehicle includes: a position detector for detecting a current position of the vehicle; a first information acquisition device for obtaining map information stored in a memory medium, wherein the map information includes road information about a position of a road, and speed limit information about a daytime speed limit and a nighttime speed limit of the road; a determination device for determining whether it is daytime or nighttime; a first specifying device for specifying the road, on which the vehicle is disposed, based on the current position of the vehicle and the map information; and a guiding device for informing the speed limit information. The guiding device informs the daytime speed limit corresponding to the road, on which the vehicle is disposed, when the determination device determines that it is daytime, and the guiding device informs the nighttime speed limit corresponding to the road, on which the vehicle is disposed, when the determination device determines that it is nighttime.

The above device provides to guide the speed limit information to the user appropriately even when the daytime speed limit is different from the nighttime speed limit.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a speed limit guiding device according to an example embodiment;

FIG. 2 is a diagram showing a relationship between a link ID and a speed limit at night and at daytime;

FIG. 3 is a diagram showing a relationship among a date, a latitude and a longitude, and a sunrise time and a sunset time;

FIG. 4 is a flowchart showing a first speed limit guidance process;

FIG. 5 is a diagram showing a screen for guiding a speed limit;

FIG. 6 is a diagram showing a relationship among a link ID, a speed limit at night and at daytime, and existence of shield object; and

FIG. 7 is a flowchart showing a second speed limit guidance process.

### DETAILED DESCRIPTION OF THE PREFERRED EMBODIMENTS

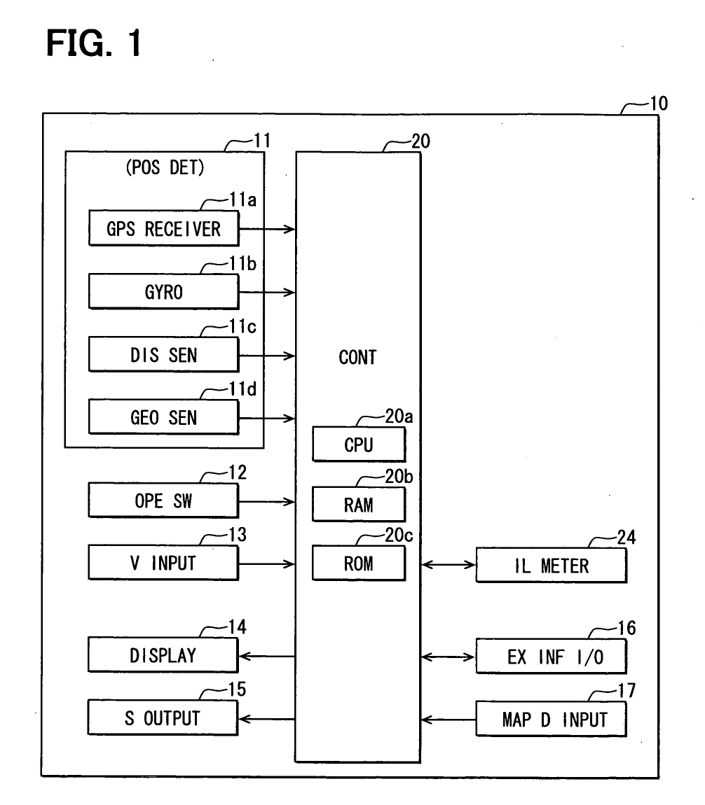

FIG. 1 shows a speed limit guiding device 10. The device 10 includes a position detector 11, multiple operation switches 12, a voice input element 13, an external information input/output element 16, a map data input element 17, a display 14, a sound output element 15, a controller 20 and an illumination meter 24. The position detector 11 detects a current position of a vehicle. The operation switches 12 function as a user interface. The voice input element 13 receives a voice and input the voice signal to the device 10. The external information input/output element 16 inputs information from and outputs information to an external device. The map data input element 17 reads out a map data from a memory medium, and inputs the map data into the controller 20. The display 14 displays the map and a route guidance screen. The sound output element 15 outputs a guiding sound. The controller executes various process based on input signals from the position detector 11, the operation switches 12, the voice input element 13, the external information input/output element 16 and the map data input element 17, and controls each unit in the device 10. The illumination meter 24 detects illumination intensity.

The position detector 11 includes a GPS receiver 11a, a gyroscope 11b, a distance sensor 11c and a geomagnetic field sensor 11d. The GPS receiver 11a receives an electric wave via a GPS antenna, the electric wave transmitted from an artificial satellite in the GPS, so that the GPS receiver 11a obtains information about an orbit of the satellite and information about current date and time. The gyroscope 11b detects rotational moment applied to the vehicle. The distance sensor 11c detects driving distance of the vehicle. The geomagnetic field sensor 11d detects a driving direction based on the geomagnetic field.

The operation switches 12 include a touch switch on a touch panel in the display 14 and a mechanical switch arranged around the display 14. The voice input element 13 includes a microphone to receive voice information from the user. The external information input/output element 16 receives the information from a beacon unit and transmits the information to the beacon unit. The beacon unit as an external device is arranged on a road. Further, the device 10 communicates with a VICS (i.e., vehicle information communication system) center via the beacon unit so that traffic information is obtained from the VICS center.

The map data input element 17 inputs the map data stored in a memory medium (not shown) into the controller 20. The memory medium stores the map data including a data showing a position of the road and a road connection data, a geological data, facility data and the like. Here, the data showing the position of the road and the road connection data is defined as a link data and a node data. Further, the map data further includes a map matching data for improving position accuracy, and a sound data for guiding a route. The memory medium may be a CD-ROM, DVD, a hard disk or the like.

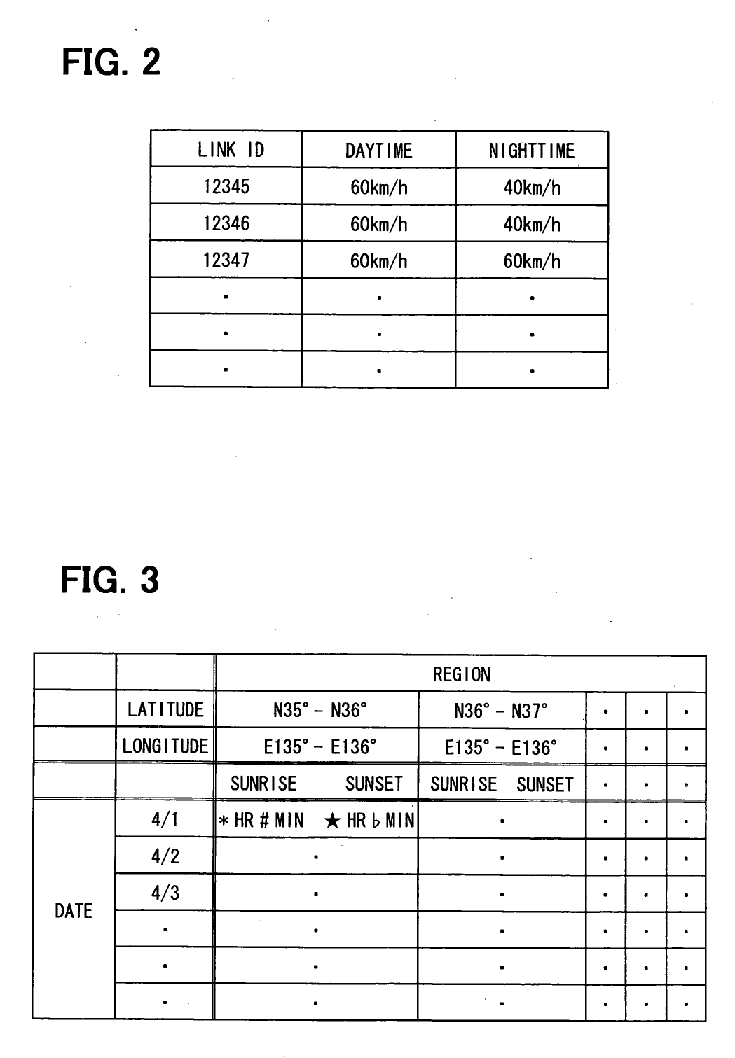

The memory medium further stores speed limit information showing the speed limit at night and at daytime, and the speed limit is related to the link ID. The link ID corresponds to each link data having position information about the road. FIG. 2 shows a relationship between the link ID and the speed limit at night and at daytime. Here, when the speed limit at night is the same as the speed limit at daytime, the same speed limit is stored in both cells of a night column and a daytime column. Further, the memory medium stores a table shown in FIG. 3. The table shows a relationship among a date, a region, a sunrise time and a sunset time. The region is defined by the latitude and the longitude. Accordingly, when the date, the latitude and the longitude are determined, the sunset time and the sunrise time are obtained.

The display 14 is a color display device including a liquid crystal monitor and the like. The display 14 is controlled by the controller 20 so that the display 14 shows the map around the current position of the vehicle, a route to the destination and the like. The destination is input by the user. The sound output element 15 includes a speaker and the like. The sound output element 15 is controlled by the controller so that the sound output element 15 outputs a voice guidance about an optimum route to the destination and a voice guidance about traffic information received via the external information input/output element 16.

The controller 20 includes a CPU 20a, a RAM 20b, a ROM 20c and the like. The CPU 20a executes various programs stored in the ROM 20c so that the controller 20 totally controls each part of the speed limit guiding device 10. Further, the controller 20 performs a map display function and a route guidance function.

The illumination meter 24 detects illumination intensity around the vehicle. Here, the illumination intensity is measured in a unit of lux. Alternatively, the illumination meter 24 may detect light flux having a unit of lumen or brightness having a unit of candera.

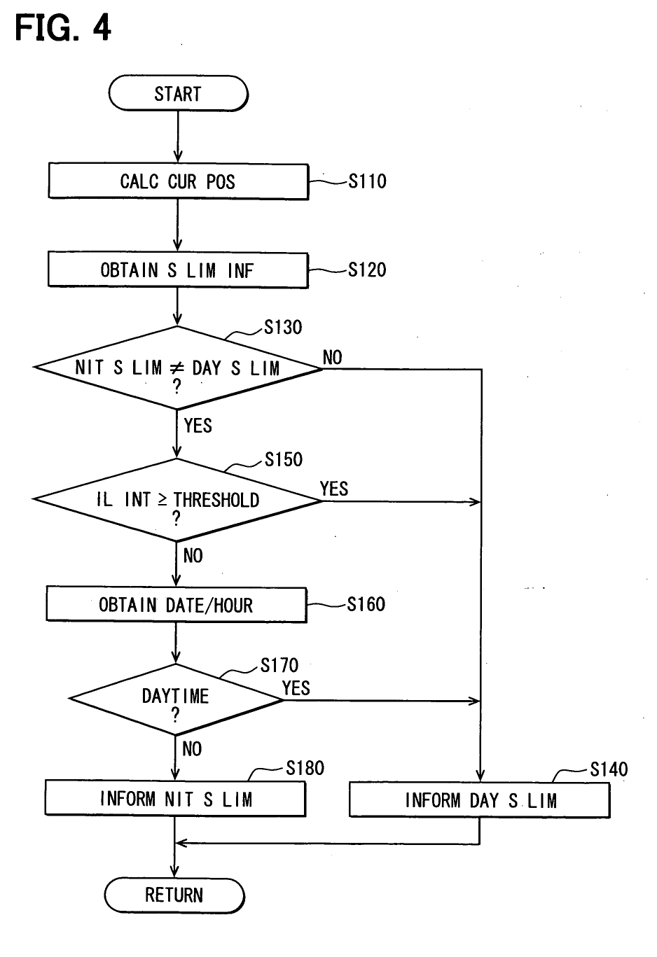

FIG. 4 shows a flowchart of a first speed limit guidance process. Mainly, the CPU 20a repeatedly executes the process. The process provides to specify the speed limit of the road, on which the vehicle having the speed limit guiding device 10 is disposed, and to guide and inform a driver of the vehicle about the speed limit. Here, the daytime is defined as a period from the sunrise to the sunset, and the night is defined as a period from the sunset to the sunrise.

In Step 110, the current position of the vehicle is calculated based on the information obtained from the position detector 11. Then, in Step S120, based on the calculated current position, the road on which the vehicle runs is specified. Then, the speed limit information corresponding to the link ID of the road is obtained from the map data input element 17.

In Step S130, it is determined whether the speed limit at night is different from the speed limit at daytime. When it is determined that the speed limit at night is the same as the speed limit at daytime, i.e., when it is determined as “NO” in Step S130, it proceeds to Step S140. In Step S140, based on the speed limit information, the speed limit at daytime is informed (or guided) to the user via the display 14 and the sound output element 15. When it is determined to “NO” in Step S130, there is no difference between the daytime speed limit and the night speed limit. In this case, the speed limit having no difference between at daytime and at night is defined as the speed limit at daytime.

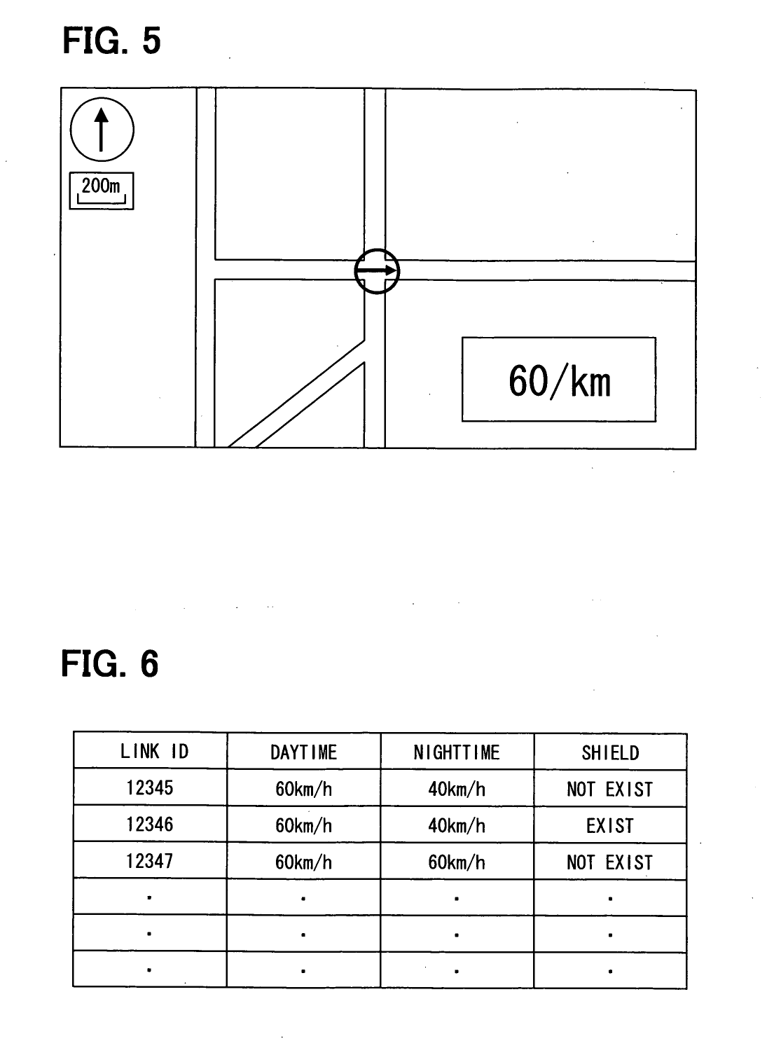

FIG. 5 shows a screen for guiding the speed limit to the user. The speed limit is overlapped with the map image on the display 14. When the speed limit is changed, a new speed limit is informed to the user via the sound output element 15.

When it is determined that the speed limit at night is different from the speed limit at daytime, i.e., when it is determined as “YES” in Step S130, it proceeds to Step S150. In Step S150, it is determined whether the illumination intensity detected by the illumination meter 24 is equal to or larger than a predetermined threshold. When it is determined that the illumination intensity is equal to or larger than the predetermined threshold, i.e., when it is determined to “YES” in Step S150, it proceeds to Step 5140. In this case, it is in daytime so that the speed limit at daytime is informed to the user via the display 14 and the sound output element 15 in Step S140. The speed limit at daytime is obtained in Step S120.

When it is determined that the illumination intensity is lower than the threshold, i.e., when it is determined to “NO” in Step S150, it proceeds to Step S160. In Step S160, the information about current date and time is obtained via the GPS receiver 11a. Based on the information about the current date and hour, in Step S170, it is determined whether the region corresponding to the current position of the vehicle at the present time is in daytime. Specifically, the information about the current date and hour and the information about the current position of the vehicle obtained in Step S110 are used for obtaining the sunrise time and the sunset time with reference to the table regarding the sunrise and sunset time shown in FIG. 3. Based on the sunrise time and the sunset time, it is determined whether it is in daytime or nighttime.

When it is determined that the region of the current position at the present time is in daytime, i.e., when it is determined to “YES” in Step S170, it proceeds to Step S140. Then, the daytime speed limit is informed. When it is determined that the region of the current position at the present time is in night time, i.e., when it is determined to “NO” in Step S170, it proceeds to Step S180. In Step S180, the daytime speed limit is informed based on the information about the speed limit obtained in Step S120. Thus, the first speed limit guidance process ends.

By executing the first speed limit guidance process, the speed limit is appropriately informed to the user with distinguishing between the daytime speed limit and the night speed limit.

### Second Embodiment

In the first embodiment, the CPU 20a in the first speed limit guidance process always reads the information of the table in FIG. 3 at night. The table is stored in the ROM 20c. Thus, processing load is increased. Thus, in the second embodiment, the daytime and the nighttime are determined based on only the current time. Specifically, determination is performed by using a predetermined time without depending on season and latitude. Thus, the processing load on the CPU 20a is reduced. Accordingly, the speed limit guiding device 10 according to the second embodiment is suitably used in a low latitude region, in which the sunset time and the sunrise time are not largely changed with the seasons.

FIG. 6 shows a table for a relationship among the link ID, the daytime speed limit and the nighttime speed limit, and the existence of shield. Thus, the memory medium stores the link ID, the speed limit information and information about the existence of shield. Here, the shield interrupts the sunshine. Specifically, the shield reduces the illumination intensity attributed to the sunshine to be smaller than a predetermined intensity. For example, the shield is a tunnel or a forest.

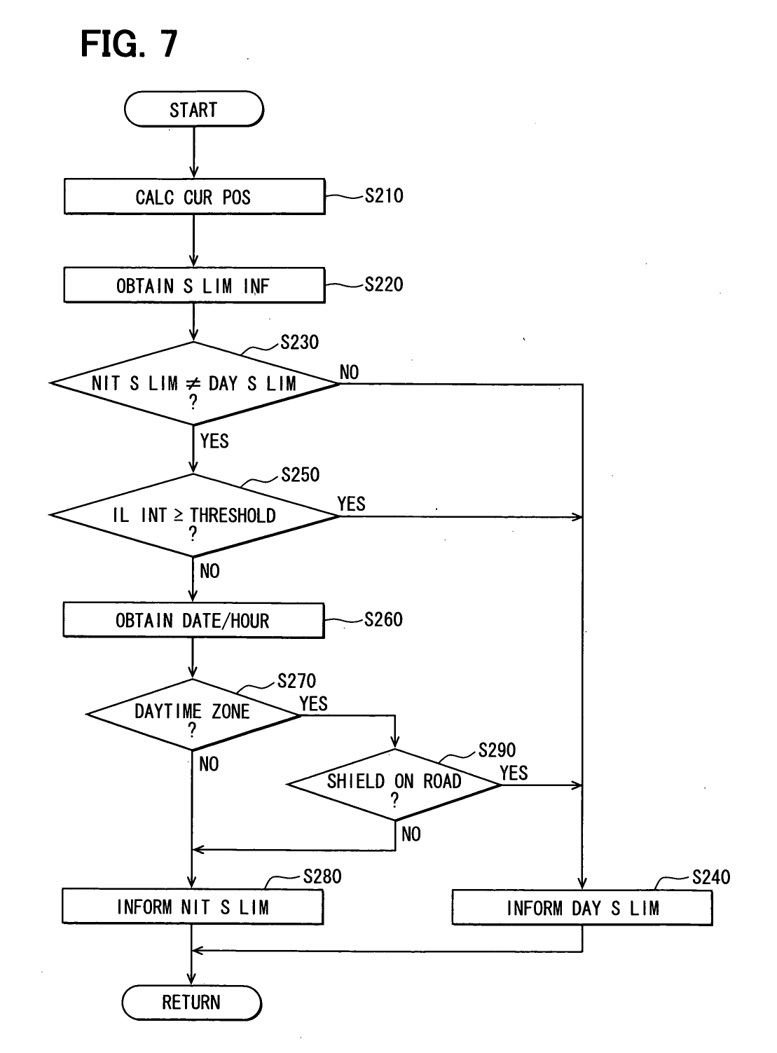

FIG. 7 shows a flowchart of a second speed limit guidance process. This process is repeatedly performed by the CPU 20a. The process is performed for specifying the speed limit at the current position at the present time and for informing the speed limit to the driver of the vehicle, on which the speed limit guiding device 10. Here, Steps S210 to S260 correspond to Steps S110 to S160, respectively.

When it proceeds to Step S270, it is determined whether the present time belongs to a predetermined daytime zone based on the present date and hour obtained via the GPS receiver 11a. When it is determined that the present time is not in the daytime zone, i.e., when it is determined to “NO” in Step S270, it proceeds to Step S280. In Step S280, the nighttime speed limit is informed to the user.

When it is determined that the present time is in the daytime zone, i.e., when it is determined to “YES” in Step S270, it proceeds to Step S290. In Step S290, the road, on which the vehicle runs, is specified based on the current position of the vehicle detected by the position detector 11. Then, the information about existence of the shield, which corresponds to the link ID of the road, so that it is determined whether the shield exists on the road. When it is determined that the shield exists on the road, i.e., when it is determined to “YES” in Step S290, it proceeds to Step S240. In Step S240, the daytime speed limit is informed to the user.

When it is determined that the shield does not exist on the road, i.e., when it is determined to “NO” in Step S290, it proceeds to Step S280. In Step S280, the nighttime speed limit is informed to the user. In Step S290, when the illumination intensity is low, and the time zone is in the daytime zone, it is determined whether the daytime speed limit or the nighttime speed limit is informed. When it is determined to “YES” in Step S290, i.e., when the shield provides reduction of the illumination intensity, it is appropriate that the daytime speed limit is informed to the user. When it is determined to“NO” in Step S290, i.e., when the shield doe not provide the reduction of the illumination intensity, the device 10 cannot specify the reason why the illumination intensity is reduced even when it is in daytime. In this case, in view of safety, the nighttime speed limit is informed.

In the second embodiment, without using the information about the sunrise time and the sunset time, the speed limit is appropriately informed to the user with distinguishing between the daytime speed limit and the night speed limit.

(Modifications)

In the first and second embodiments, the device 10 includes the illumination meter 24. Alternatively, the device may not include the illumination meter 24. In this case, Step S150 in the first speed limit guidance process and Step S250 in the second speed limit guidance process are skipped. Thus, the manufacturing cost of the device 10 is reduced.

However, in the above case, the processing load of the CPU 20a increases. The reason why the processing load increases will be explained as follows. By using the illumination meter, it is easy to determine that the present time is in daytime. However, when the device 10 does not include the illumination meter, the device 10 have to obtain the date and time information via the GPS receiver 11a in every process. Based on the date and time information, the device 10 executes a step for determining whether the present time is in daytime or at night. Thus, the device 10 has to execute some steps, so that the processing load increases.

The selection of the device 10 among the first, second embodiments and above modification may be performed in view of instruction of a traffic sign.

Although the speed limit of the road is changed in accordance with the difference between daytime and night, the speed limit may be changed in a different manner. For example, the speed limit of a road near a school may be changed to be low in a commute time zone on weekdays. In this case, the conditions are stored in the device 10 such that the conditions relates to a link ID of the road. Thus, the device 10 informs the speed limit to the user in view of the conditions. Further, without using the information about time, the device 10 may determine based on the illumination intensity whether it is daytime or night.

Steps S150 to S170 corresponds to a determination means, and Steps S140 and S180 corresponds to a communication means. Steps S250 to S270 corresponds to a determination means, Step S290 corresponds to a correction means, and Steps S240 and S280 correspond to a communication means.

The above disclosure has the following aspects.

According to an aspect of the present disclosure, a speed limit guiding device for a vehicle includes: a position detector for detecting a current position of the vehicle; a first information acquisition device for obtaining map information stored in a memory medium, wherein the map information includes road information about a position of a road, and speed limit information about a daytime speed limit and a nighttime speed limit of the road; a determination device for determining whether it is daytime or nighttime; a first specifying device for specifying the road, on which the vehicle is disposed, based on the current position of the vehicle and the map information; and a guiding device for informing the speed limit information. The guiding device informs the daytime speed limit corresponding to the road, on which the vehicle is disposed, when the determination device determines that it is daytime, and the guiding device informs the nighttime speed limit corresponding to the road, on which the vehicle is disposed, when the determination device determines that it is nighttime.

The above device provides to guide the speed limit information to the user appropriately even when the daytime speed limit is different from the nighttime speed limit.

Alternatively, the determination device may include a sensor for detecting one of brightness, illumination intensity and light flux around the vehicle, and the determination device determines based on detection result of the sensor whether it is daytime or nighttime. In this case, based on the one of brightness, illumination intensity and light flux, the device can determines whether it is daytime or nighttime. Further, the determination device may determine that it is daytime when the one of brightness, illumination intensity and light flux is equal to or larger than a predetermined threshold, and the determination device may determine that it is nighttime when the one of brightness, illumination intensity and light flux is smaller than the predetermined threshold.

Alternatively, the speed limit guiding device may further include: a second information acquisition device for obtaining date and time information; and a second specifying device for specifying a sunrise time and a sunset time based on the date and time information and the current position of the vehicle. The determination device determines based on the date and time information, the sunrise time and the sunset time whether the present time is in daytime from the sunrise time to the sunset time or in nighttime from the sunset time to the sunrise time.

Alternatively, the determination device may further include a time acquisition device for obtaining time information. The determination device determines based on the detection result of the sensor and the time information whether it is daytime or nighttime. If weather is bad, or if the vehicle enters into a dark place such as a shaded area, it is difficult to determine based on only the detection result of the sensor whether it is daytime or nighttime. However, when the determination device further includes the time acquisition device, the device determines with high accuracy whether it is daytime or nighttime. Further, the determination device may determine that it is daytime when the one of brightness, illumination intensity and light flux is equal to or larger than a predetermined threshold, or when the present time is disposed in a predetermined daytime zone, and the determination device may determine that it is nighttime when the one of brightness, illumination intensity and light flux is smaller than the predetermined threshold, and when the present time is disposed in a predetermined nighttime zone. Further, the speed limit guiding device may further include: a correction device. The first information acquisition device further obtains shield information from the memory medium. The shield information shows a position of a shield, which interrupts the sunshine, and the correction device corrects determination result of the determination device based on the current position of the vehicle and the shield information. In this case, the device can determine with high accuracy whether it is daytime or nighttime. For example, even if it is dark, the darkness would be provided from the shield for blocking the sunshine. In this case, it is proper to determine that it is daytime. Thus, the correction device provides high accuracy. Further, the correction device may switch from the determination result of daytime to nighttime when the one of brightness, illumination intensity and light flux is smaller than the predetermined threshold, when the present time is disposed in a predetermined daytime zone, and when the current position of the vehicle does not coincide with the position of the shield.

Alternatively, the speed limit guiding device may further include: a second information acquisition device for obtaining date and time information; and a second specifying device for specifying a sunrise time and a sunset time based on the date and time information and the current position of the vehicle. The determination device includes a sensor for detecting one of brightness, illumination intensity and light flux around the vehicle. The determination device determines that it is daytime when the one of brightness, illumination intensity and light flux is equal to or larger than a predetermined threshold, or when the present time is in daytime from the sunrise time to the sunset time, and the determination device determines that it is nighttime when the one of brightness, illumination intensity and light flux is smaller than the predetermined threshold, and when the present time is in nighttime from the sunset time to the sunrise time.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A speed limit guiding device for a vehicle comprising:
a position detector for detecting a current position of the vehicle;
a first information acquisition device for obtaining map information stored in a memory medium, wherein the map information includes road information about a position of a road, and speed limit information about a daytime speed limit and a nighttime speed limit of the road;
a determination device for determining whether it is daytime or nighttime;
a first specifying device for specifying the road, on which the vehicle is disposed, based on the current position of the vehicle and the map information; and
a guiding device for informing the speed limit information,
wherein the guiding device informs the daytime speed limit corresponding to the road, on which the vehicle is disposed, when the determination device determines that it is daytime, and
wherein the guiding device informs the nighttime speed limit corresponding to the road, on which the vehicle is disposed, when the determination device determines that it is nighttime.

2. The speed limit guiding device according to claim 1,
wherein the determination device includes a sensor for detecting one of brightness, illumination intensity and light flux around the vehicle, and
wherein the determination device determines based on detection result of the sensor whether it is daytime or nighttime.

3. The speed limit guiding device according to claim 2,
wherein the determination device determines that it is daytime when the one of brightness, illumination intensity and light flux is equal to or larger than a predetermined threshold, and
wherein the determination device determines that it is nighttime when the one of brightness, illumination intensity and light flux is smaller than the predetermined threshold.

4. The speed limit guiding device according to claim 1, further comprising:
a second information acquisition device for obtaining date and time information; and
a second specifying device for specifying a sunrise time and a sunset time based on the date and time information and the current position of the vehicle,
wherein the determination device determines based on the date and time information, the sunrise time and the sunset time whether the present time is in daytime from the sunrise time to the sunset time or in nighttime from the sunset time to the sunrise time.

5. The speed limit guiding device according to claim 2,
wherein the determination device further includes a time acquisition device for obtaining time information, and
wherein the determination device determines based on the detection result of the sensor and the time information whether it is daytime or nighttime.

6. The speed limit guiding device according to claim 5,
wherein the determination device determines that it is daytime when the one of brightness, illumination intensity and light flux is equal to or larger than a predetermined threshold, or when the present time is disposed in a predetermined daytime zone, and
wherein the determination device determines that it is nighttime when the one of brightness, illumination intensity and light flux is smaller than the predetermined threshold, and when the present time is disposed in a predetermined nighttime zone.

7. The speed limit guiding device according to claim 5, further comprising:
a correction device,
wherein the first information acquisition device further obtains shield information from the memory medium,
wherein the shield information shows a position of a shield, which interrupts the sunshine, and
wherein the correction device corrects determination result of the determination device based on the current position of the vehicle and the shield information.

8. The speed limit guiding device according to claim 7,
wherein the correction device switches from the determination result of daytime to nighttime when the one of brightness, illumination intensity and light flux is smaller than the predetermined threshold, when the present time is disposed in a predetermined daytime zone, and when the current position of the vehicle does not coincide with the position of the shield.

9. The speed limit guiding device according to claim 1, further comprising:
a second information acquisition device for obtaining date and time information; and
a second specifying device for specifying a sunrise time and a sunset time based on the date and time information and the current position of the vehicle,
wherein the determination device includes a sensor for detecting one of brightness, illumination intensity and light flux around the vehicle,
wherein the determination device determines that it is daytime when the one of brightness, illumination intensity and light flux is equal to or larger than a predetermined threshold, or when the present time is in daytime from the sunrise time to the sunset time, and
wherein the determination device determines that it is nighttime when the one of brightness, illumination intensity and light flux is smaller than the predetermined threshold, and when the present time is in nighttime from the sunset time to the sunrise time.
